(19) United States
(12) Patent Application Publication
(10) Pub. No.: US 2010/0172726 A1
(43) Pub. Date: Jul. 8, 2010

(54) RAIL TRAY SYSTEM AND METHOD

(76) Inventors: Ronald G. Russ, Parkville, MO (US); Roger D. Sims, Highland, IN (US); Ed Bell, Chesterton, IN (US); Bruce Fetterman, Parkville, MO (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/436,738

(22) Filed: May 6, 2009

Related U.S. Application Data
(60) Provisional application No. 61/050,947, filed on May 6, 2008.

(51) Int. Cl. B61D 47/00; B65G 67/04; B65G 67/10; B61D 3/02; B65G 67/20

(52) U.S. Cl. 414/343; 414/352; 414/800; 105/355

(57) ABSTRACT

A system and method to load and unload railcars using stackable trays having an internal propulsion system.

### CROSS REFERENCE TO RELATED APPLICATION

This patent application is related to and claims priority from U.S. Provisional Patent Application Ser. No. 61/050,947 filed May 6, 2008 and is incorporated by reference in its entirety. Further, U.S. Pat. No. 6,799,933 is incorporated by reference in its entirety.

### BACKGROUND OF THE INVENTION

1. Field of the Invention

The present general inventive concept relates to a system and method to load and unload a railcar, and more particularly, to a railcar tray system having stackable trays that include various features such as an internal propulsion system to facilitate the loading and unloading of the stackable trays within the railcar and between two or more cars.

2. Description of the Related Art

Pallets are commonly used as a platform to facilitate the handling of stacked items and transportation of goods via truck, rail, air, boat or other transportation method.

Individual pallets usually have suitable holes therein to accept the prongs of a fork-lift truck. A pallet can thereby be loaded into and unloaded from trucks, trailers, freight train cars or the like for transport and delivery to a final destination for the particular goods thereon.

Each pallet is so moved individually to its desired destination by the operator of a fork-lift truck. This is a time-consuming process. Moreover, once placed onto a truck, trailer, freight train railcar or the like, the goods stacked on the pallet may shift thereby causing damage to the goods and presenting a hazard to those later unloading the pallet.

Loading a pallet into a railcar presents an additional complication. Typically, a plurality of railcars are connected to each other, which requires disconnecting one railcar from another to accept the pallet. Rather than disconnect each railcar to be loaded, a pallet will be loaded into a first railcar and then conveyed through the first rail car to one or more railcars for placement in a second railcar.

Given small gaps between railcars, movement of the pallet between railcars via traditional means is a tedious process requiring extreme caution.

Accordingly, there is an unsolved need in the state of the art for a freight load pallet carrier and mover apparatus and method to accept a plurality of pallets for securing goods thereon, to provide simplified and efficient loading and unloading of the pallets, and to provide simplified and efficient transferring of pallets from one railcar to another.

### SUMMARY OF THE INVENTION

The present general inventive concept provides a railcar pallet or tray system and method having various features to facilitate the loading and unloading of railcars via stacking trays.

The present general inventive concept also provides a railcar tray system and method that is capable of moving the stackable trays or small platforms in and out of a railcar using an internal propulsion system within the railcar.

The present general inventive concept also provides a railcar tray system and method that allows stacking of the trays at three levels within the railcar.

The present general inventive concept also provides a railcar tray system and method having a drive system that provides enhanced traction via a drive roller that pushes against and otherwise motivates the tray spine or plate by torsion springs.

The present general inventive concept also provides a railcar tray system and method having a drive system that provides enhanced traction via a compliant drive roller which maintains a high coefficient of friction between the drive roller and the tray spine or plate.

The present general inventive concept also provides a railcar tray system and method having an additional feature that may be added to the drive roller to make it ‘hour glass’ shaped so that when the spine or plate has a matching contour, the pairing of these two elements provide a centering function.

The present general inventive concept also provides a railcar tray system and method having a spine or plate that may be segmented as illustrated or run continuously down the length of the tray.

The present general inventive concept also provides a railcar tray system and method having a spine plate that when segmented, a half round piece may be attached to the bottom of each lateral tray member to guide the tray over those short sections.

The present general inventive concept also provides a railcar tray system and method having a tray that is uniquely designed and constructed so that it can span from a first railcar to an adjacent second railcar without the need or use of any bridge plate or other ancillary device.

The present general inventive concept also provides a railcar tray system and method having a tray with spaced travel rollers and a structure having sufficient structural integrity to maintain a load when a portion of the tray is unsupported while moving, rolling, or otherwise conveying a load from a first rail vehicle to an adjacent second rail vehicle.

The present general inventive concept also provides a railcar tray system and method having a receiving area to enhance reception of a tray so that upon moving from one railcar to an adjacent railcar, the tray enhances efficiency of the move permitting a smooth reception of the tray as it bridges itself across an opening between the railcars.

The present general inventive concept also provides a railcar tray system and method having a receiving area to enhance reception of a tray wherein the tray facilitates such reception via a ‘lead-in’ for the drive roller.

The present general inventive concept also provides a railcar tray system and method having unique railcar end doors with four large panels that may be sealed against the elements by a unique combination of primary seals that close off and otherwise eliminate space between the inner door surface and a companion sealing purpose or corresponding structure of the railcar.

The present general inventive concept also provides a railcar tray system and method having primary seals that are further enhanced by compression gaskets between the door panels.

The present general inventive concept also provides a railcar tray system and method having a secondary level of weather-tightness via one or more drip guards which are situated along vertical seams of the door panels so that if moisture penetrates the vertical compression gaskets between the door panels, the one or more drip guards will deflect moisture away from cargo and a railcar interior and direct the moisture to the bottom of the car where moisture is permitted to exit onto the ground.

The present general inventive concept also provides a railcar tray system and method having a series of baffles that deflect water out of the railcar thus preventing any water outside of the railcar from entering the railcar.

The present general inventive concept also provides a railcar tray system and method having a railcar top (⅓ thereof) with a unique physical and structural configuration wherein a Plate H design clearance envelope permits containers to be stacked two high in a well type double stack container car and has a relatively narrow space to house a third or ‘C’ deck tray.

The present general inventive concept also provides a railcar tray system and method having a ‘C’ deck structural support situated into a small design space where the Plate H clearance diagram narrows.

The present general inventive concept also provides a railcar tray system and method having locks to secure the stackable trays in place at all three levels simultaneously.

The present general inventive concept also provides a railcar tray system and method having locks with lock handles wherein the lock handles indicate to the loading crew when the load is secured for transportation.

The present general inventive concept also provides a railcar tray system and method having lock handles that protrude outward from the car side when unlocked to indicate to the loading crew when the load is secured for transportation.

The present general inventive concept also provides a railcar tray system and method having a locking arrangement that secures the trays for transportation in a confined space.

The present general inventive concept also provides a railcar tray system and method having a locking arrangement that secures the trays for transportation without compromising the weather-tightness of the railcar nor allowing the trays to contact the end door, thereby preventing damage.

The present general inventive concept also provides a railcar tray system and method having a locking mechanism that utilizes an electronic interface between the lock and the tray, thereby providing for energy absorption and minimizing wear.

The present general inventive concept also provides a railcar tray system and method having a bulkhead used to secure a lading on the trays wherein the lading utilizes a roller on each side so that the bulkhead can be positioned properly by hand and efficiently secured to the tray.

The present general inventive concept also provides a railcar tray system and method having means of securing a load that uses friction under the pallets in combination with longitudinal restraint of the bulkhead to adequately secure the load in anticipation of over-the-road movements as well as yard impacts due to classification yard operations.

The present general inventive concept also provides a railcar tray system and method having a hole spacing in the bulkhead side plate along with a fastener hole spacing on the tray designed to provide for a 1″ longitudinal adjustment of the bulkhead relative to the tray.

The present general inventive concept also provides a railcar tray system and method having travel rollers with an ‘hour glass’ shape that ride on a track which provide a guiding or centering feature.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to move one or more trays within a railcar or between railcars including a tray propulsion system housed within the railcar to move the one or more trays on at least two levels of the railcar; and an arm to (i) securely stop movement of the one or more trays and (ii) indicate to a user whether the one or more trays are in one of a secured position and a released position.

The propulsion system may be a mechanical system without energizing means to power the propulsion system.

The propulsion system may have an engagement element for each of the one or more trays that engages and is powered by a hand-powered tool.

The one or more trays may be stackable.

The one or more trays may include three trays stacked on top of each other.

The foregoing and/or other aspects and utilities of the present general inventive concept may also be achieved by providing a method for moving one or more trays within a railcar or between railcars including activating a tray propulsion system housed within the railcar to move the one or more trays; and moving an arm to (i) securely stop movement of the one or more trays and (ii) indicate whether the one or more trays are in one of a secured position and a released position.

The foregoing and/or other aspects and utilities of the present general inventive concept may also be achieved by providing a freight load carrier to receive items thereon that is conveyable through one or more railcars for placement into a railcar, the carrier including a frame having a first end and a second end with longitudinal support members spacing the first end from the second end and a plurality of lateral support members therebetween; an upper surface to receive one or more items thereon, the upper surface supported by the frame; a tray propulsion engagement element on at least one of the first end and the second end, the tray propulsion engagement element configured to engage a tray propulsion system housed within the railcar; and a conveyance facilitation element to facilitate delivery of the tray into the one or more railcars.

The carrier may include a grating on the upper surface to provide an increased coefficient of friction.

The carrier may include an elastomer stopper engagement element to abut a stopper.

The carrier may include a plurality of rollers situated substantially within each of the lateral support elements.

Each of the plurality of rollers may have an hour-glass shaped cross-section.

The carrier may include an end element to abut a stopper and secure the tray in a position.

The upper surface may have a first portion that spaces a second portion from a third portion, the second portion and the third portion having a structural integrity that is greater than a structural integrity of the first portion.

The carrier may include a bulkhead on at least one of the first end and the second end to secure via abutting engagement the one or more items received on the upper surface.

The bulkhead may have a longitudinally adjustable element to permit incremental adjustments of the bulkhead depending on the one or more items received on the upper surface.

The carrier may include guides on each of the longitudinal support members facing away from the frame.

The guides may have a “C” configuration to receive an element therein.

The foregoing and/or other aspects and utilities of the present general inventive concept may also be achieved by providing a railcar including a housing having a housing cavity therein and end doors on opposite ends of the housing; at least two floors within a housing cavity, each of the at least two floors configured to receive a tray; a propulsion means on each of the at least two floors configured to engage and move the tray; and an operation station to receive a hand tool to permit independent operation of the propulsion means on each of the at least two floors.

The railcar may have three floors, each of the three floors configured to receive a tray.

Each of the end doors may have a left door and a right door that open outwardly with respect to the housing to expose the housing cavity, each of the left door and right door having a split to enable folding of the left door and the right door away from the housing.

Each of the end doors may have a gasket configured to be compressed when the end doors are in a closed configuration and decompressed when the doors are in an open configuration.

The railcar may have a splash guard secured to one of the end doors to deter water from entering the housing cavity.

The splash guard may be secured to an interior of one of the end doors and extends in a first direction away from the one of the end doors and is bent in a second direction toward another of the end doors.

Each of the at least two floors may have a track on either side of the floor.

The propulsion means may be situated between the track on either side of the floor.

The propulsion means may include an abutment element that is (i) biased in a direction, (ii) rotatable, (iii) connected to a torsion spring, and (iv) connected to the operation station.

The abutment element may be configured to rotate upon abutting engagement of a tray.

The abutment element may be biased in an upward direction via the torsion spring.

The abutment element may be selectively rotatable in a first direction and a second direction via the operation station.

The railcar may have an indicative securing element that (i) may be selectively moveable from a secured configuration to secure a load and an unsecured configuration to permit movement of a load and (ii) may indicate when the indicative securing element is in the secured configuration or the unsecured configuration.

The indicative securing element may be connected to a stopper.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view of the present general inventive concept illustrating a railcar arriving at a warehouse for loading.

FIG. 2 is a rear elevational view of the present general inventive concept illustrating a railcar in a Plate H clearance diagram, wherein a clearance envelope is shown around the perimeter of the car conforming to Association of American Railroads standards.

FIG. 3 is a perspective view of the present general inventive concept illustrating a stackable tray (flat deck) with structure in phantom.

FIG. 4 is a perspective view of the present general inventive concept illustrating a tray with diamond floor and elastomer pads at 4 corners thereof with holes on a side member for bulkhead engagement. A center channel is shown which cooperates with one or more propulsion rollers as described further herein. A side member with a plurality of holes formed therein is provided for removable attachment to a bulkhead.

FIG. 5 is a bottom perspective view of the present general inventive concept illustrating a tray having an understructure with lateral support design, longitudinal members, and reinforced portion.

FIG. 6 is an enlarged fragmentary bottom perspective view of the present general inventive concept illustrating a tray having an understructure with lateral support design, longitudinal members, and reinforced portion. A glide roller, which forms part of the propulsion system, is depicted. In a preferred embodiment the glide rollers are spaced apart every 6 feet along the side of the tray.

FIG. 7 is a perspective view of the present general inventive concept illustrating a tray bulkhead with wheel. The bulkhead is configured to wrap around pallets or cargo loaded onto the tray for support and to move the cargo along the tray. A pair of rollers (one of which is shown) are provided for moving the bulkhead along the tray. Pins (not shown) are utilized to lock the bulkhead in place at the desired location.

FIG. 8 is a perspective view of the present general inventive concept illustrating a tray bulkhead in use. A pair of bumpers are shown and may be engaged by lock bars as illustrated herein.

FIG. 9 is a perspective view of the present general inventive concept illustrating a railcar rear interior with folding door. A plurality of rubber wheels are shown which form part of the propulsion system. In a preferred embodiment 6 wheels are provided per car.

FIG. 10 is a perspective view of the present general inventive concept illustrating a propulsion drive system (with railcar structure removed) wherein in a preferred embodiment an impact wrench may engage a drive shaft(s) to drive a sprocket depending on deck. Torsion springs are provided to drive the rollers. Belts are provided to power the drive shafts between the A, B and C decks. In alternative embodiments external sources such as a pneumatic or electric power source may be utilized. It is also foreseen that a chain drive system could be utilized.

FIG. 11 is a magnified perspective view of the present general inventive concept illustrating a propulsion drive system with torsion spring to bias the unit upwards or otherwise provide a propensity to rise upward and lead-in to bias the roller downward upon contacting a tray. The drive wheel rotates to lead in the tray at the nose and push (or pull) the roller down the length or the car.

FIG. 12 is a perspective view of the present general inventive concept illustrating a rear of railcar having an indicator handle. Three drive shafts are also shown (for use with the wrench system).

FIG. 13 is a perspective view of the present general inventive concept illustrating an interior of a railcar and indicator handle engagement mechanism with a tray stopper in a raised position. The stopper is movable to a locked or extended position to prevent the tray from moving in the car. In the release position the trays may be moved along the car or loaded or unloaded.

FIG. 14 is a perspective view of the present general inventive concept illustrating an interior of a railcar and a tray stopper in a lowered position engaged with a tray.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

The present general inventive concept provides a railcar tray system and method having various features to facilitate the loading and unloading of railcars via stacking trays.

The railcar tray system and method is capable of moving the trays or small platforms in and out of a railcar using an internal propulsion system within the railcar. See FIG. 8.

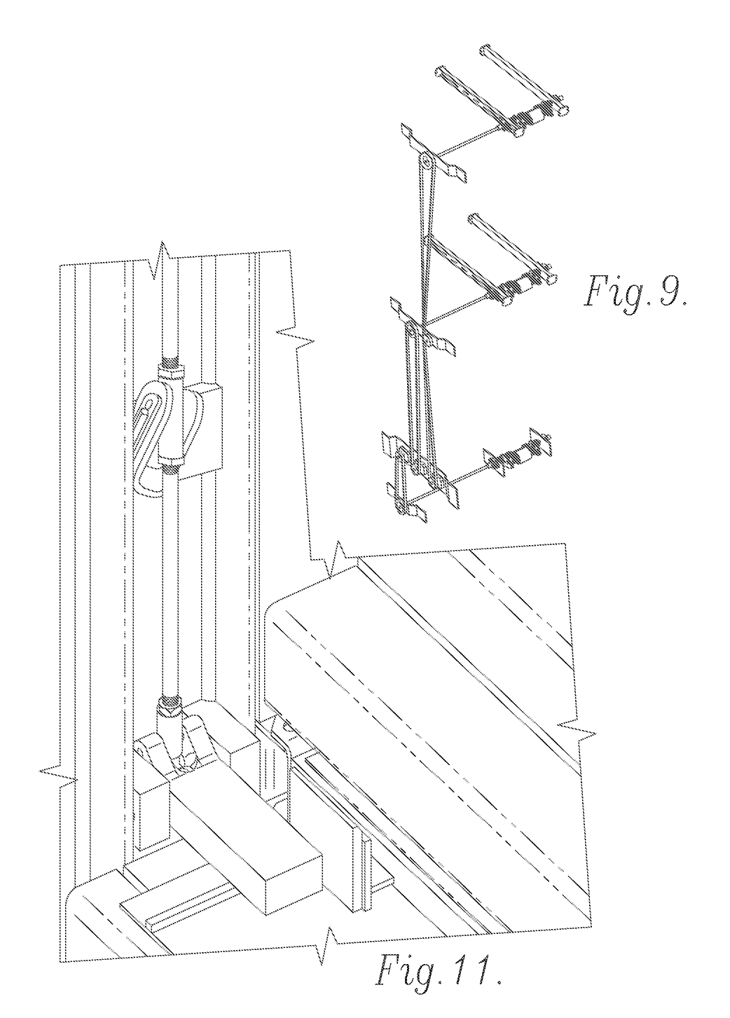

The railcar tray system and method allows stacking of the trays at three levels within the railcar. See FIGS. 9, 10, and 16.

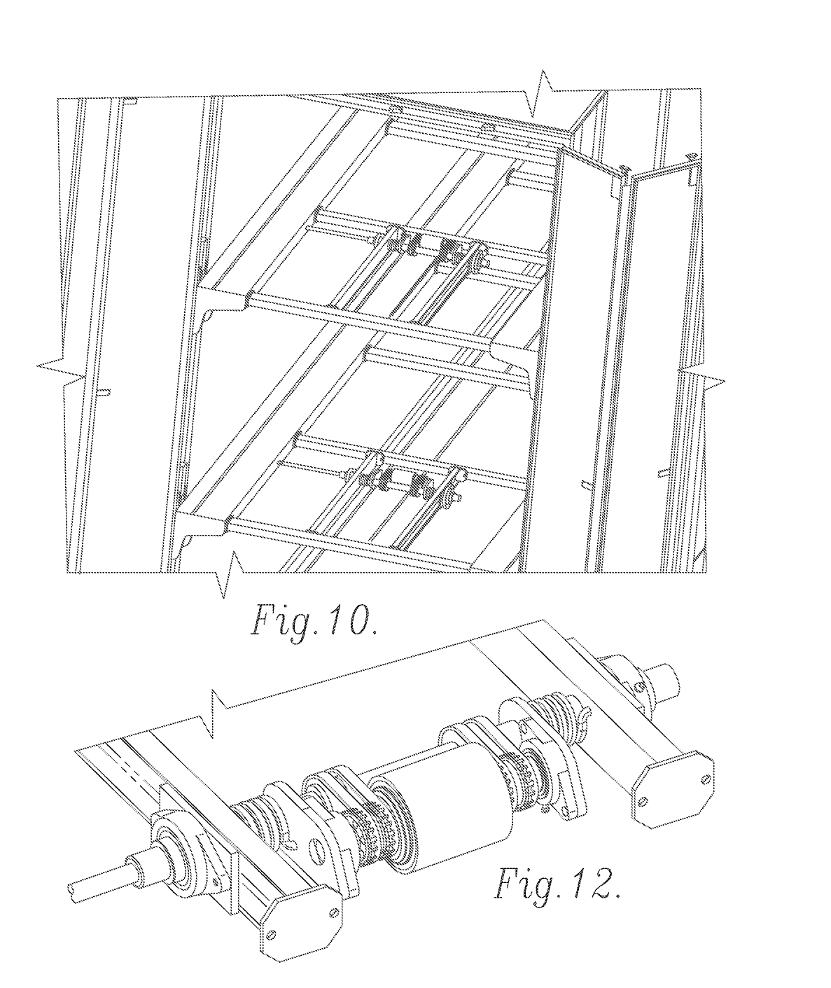

The railcar tray system has a drive system with enhanced ‘traction’ via a drive roller that pushes against and otherwise motivates the tray spine or plate by torsion springs. See FIG. 10.

Traction is further enhanced by a compliant drive roller which maintains a high coefficient of friction between the drive roller and the tray spine or plate. See FIG. 10.

An additional feature that can be added to the drive roller is to make it ‘hour glass’ shaped. When the spine or plate has a matching contour, the pairing of these two items results in a centering feature. The spine or plate can be segmented or run continuously down the length of the tray.

When the spine or plate is segmented a half round piece is attached to the bottom of each lateral tray member to guide the tray over those short sections.

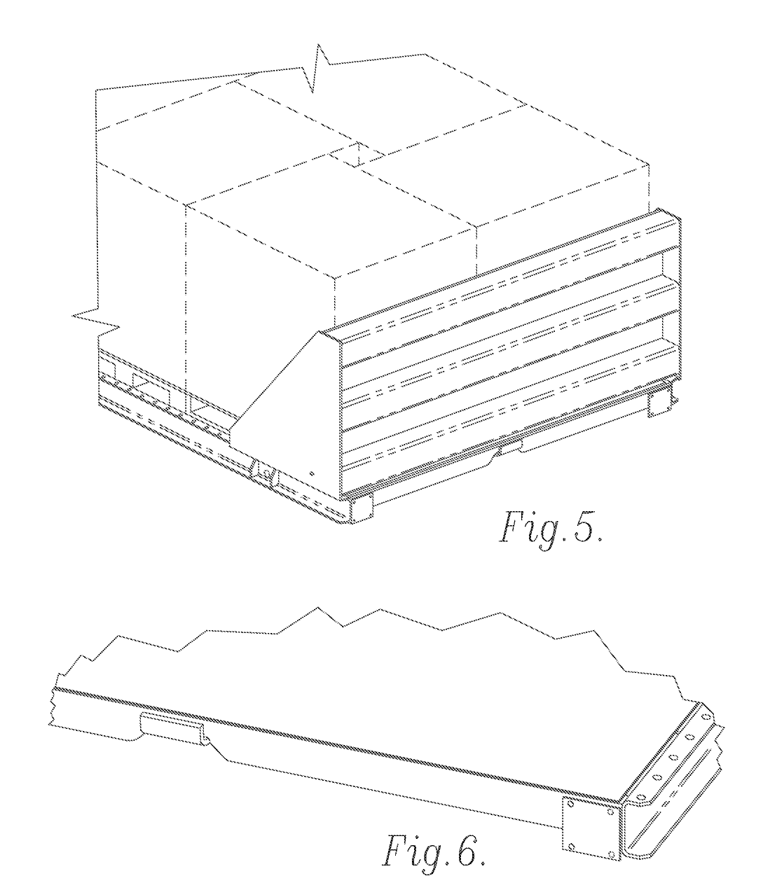

The tray itself is uniquely designed and constructed so that it can span from railcar to railcar without the need or use of any bridge plate or other ancillary device. See FIG. 5

The details of this tray feature includes the spacing of the travel rollers and the structure of the tray, especially in the portion of the tray which is unsupported while between rail vehicles. See FIG. 5.

This tray feature is further enhanced by the receiving area of the adjacent railcar, which allows for a smooth reception of the tray as it bridges itself across the opening via, inter alia, a tray ‘lead-in’ for the drive roller. See FIGS. 5, 6, 10, and 11.

The end doors of the railcar are unique because the four large panels can be sealed against the elements by a unique combination of primary seals. These seals close off space between the inner door surface and the companion sealing purpose of the railcar. These primary seals are further enhanced by compression gaskets between the door panels.

A secondary level of weather-tightness is a drip guard which is present along the vertical seams of the door panels. Should any moisture penetrate the vertical compression gaskets between the door panels, these drip guards will deflect moisture away from the cargo and the car interior down to the bottom of the car, where moisture will exit to the ground.

A series of baffles will deflect this water out of the railcar while not allowing water from the outside of the railcar to enter (not illustrated).

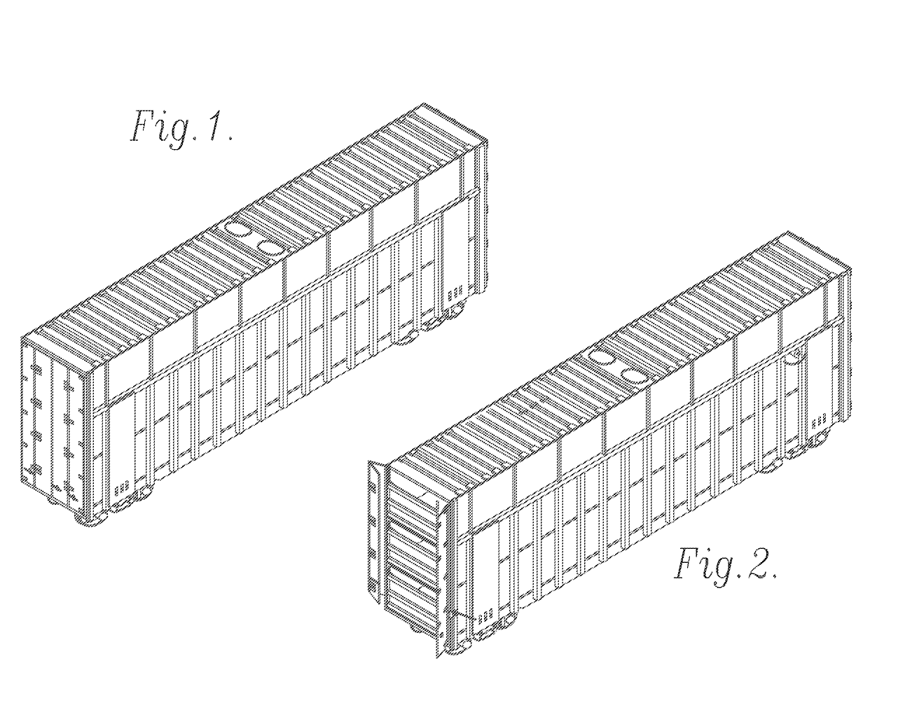

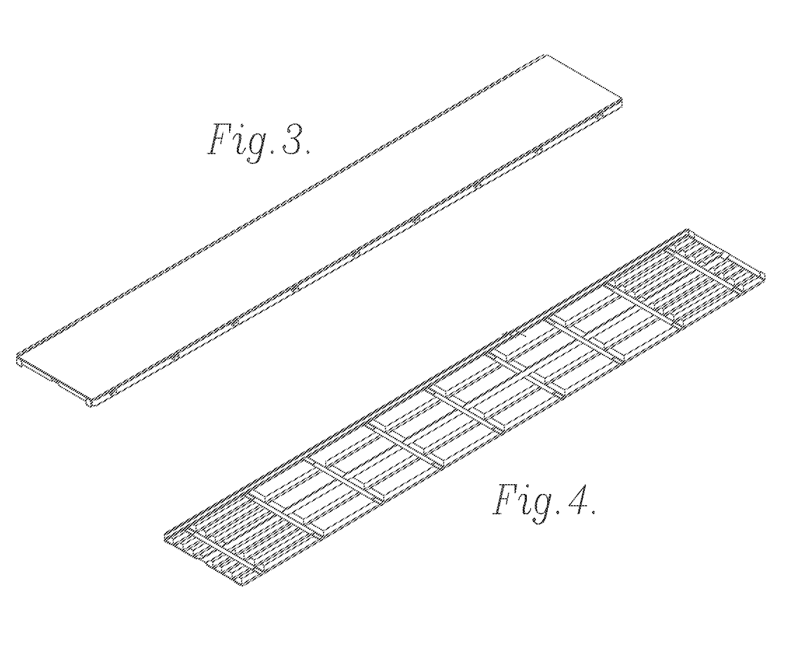

The physical and structural configuration of the top ⅓ of the railcar is unique. The Plate H design clearance envelope allows containers to be stacked two high in a well type double stack container car. See FIG. 2. This design of the present general inventive concept utilizes this relatively narrow space to house the third or ‘C’ deck tray. The ‘C’ deck structural support is uniquely tucked into a small design space where the Plate H clearance diagram narrows.

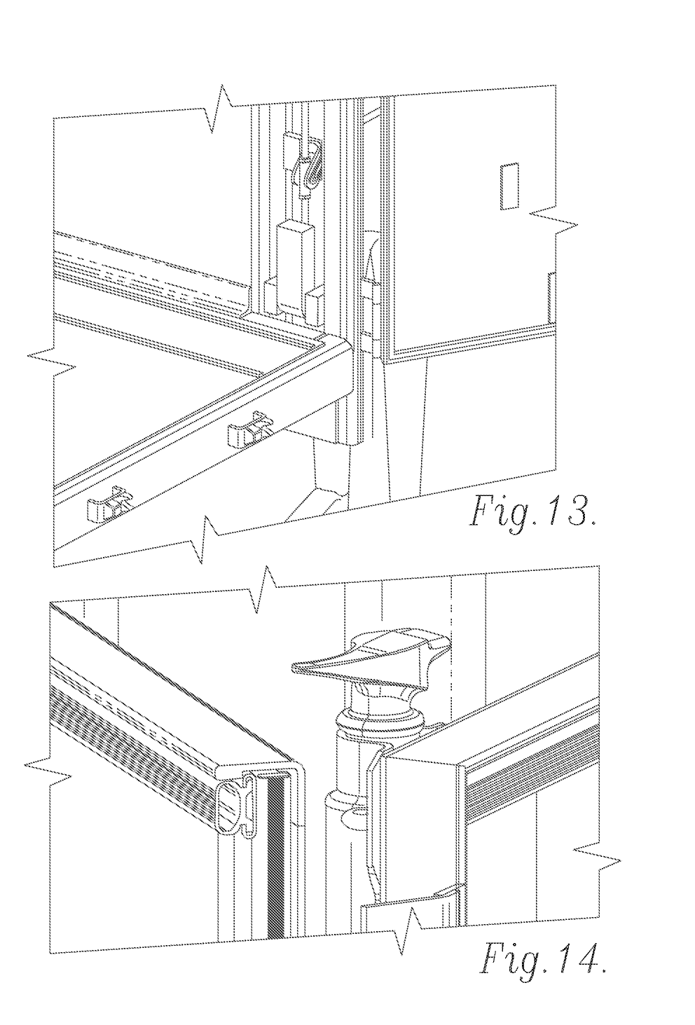

The locks secure the trays in place at all three levels simultaneously and uniquely use the actual lock handle as an indicator to the loading crew when the load is secured for transportation. Specifically, the handle protrudes outward/upward from the car side when unlocked and inward/downward when locked. See FIG. 12. The locking arrangement secures the trays in a very confined design space and does so without compromising the weather-tightness of the railcar nor allowing the trays to contact the end door which could damage them. The locking mechanism may utilize an electronic interface between the lock and the tray, which provides for some energy absorption and minimizes wear. See FIG. 13.

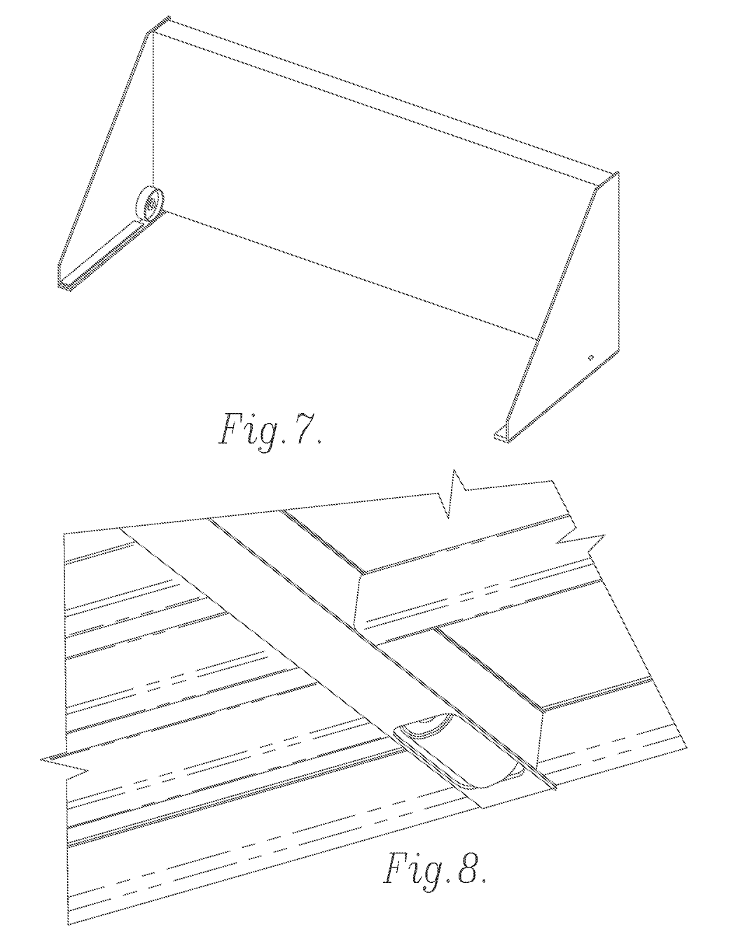

The bulkhead used to secure the lading on the trays is unique. It utilizes a roller on each side so that the bulkhead can be positioned properly by hand and efficiently secured to the tray. See FIG. 7. The combination of friction under the pallets and the longitudinal restraint of the bulkhead provides a unique means of securing the load for the over-the-road movements as well as yard impacts due to classification yard operations. See FIG. 8. The hole spacing in the bulkhead side plate along with the fastener hole spacing on the tray are designed to provide a 1″ longitudinal adjustment of the bulkhead relative to the tray.

With regard to Item 5, the travel rollers could have an ‘hour glass’ shape and ride on a track which would provide a guiding or centering feature.

Although a few embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An apparatus to move one or more trays within a railcar or between railcars comprising:
a tray propulsion system housed within the railcar to move the one or more trays on at least two levels of the railcar; and
an arm to (i) securely stop movement of the one or more trays and (ii) indicate to a user whether the one or more trays are in one of a secured position and a released position.

2. The apparatus to move one or more trays according to claim 1, wherein the propulsion system is a mechanical system without energizing means to power the propulsion system.

3. The apparatus to move one or more trays according to claim 1, wherein the propulsion system has an engagement element for each of the one or more trays that engages and is powered by a hand-powered tool.

4. The apparatus to move one or more trays according to claim 1, wherein the one or more trays are stackable.

5. The apparatus to move one or more trays according to claim 1, wherein one or more trays include three trays stacked on top of each other.

6. A method for moving one or more trays within a railcar or between railcars comprising:
activating a tray propulsion system housed within the railcar to move the one or more trays; and
moving an arm to (i) securely stop movement of the one or more trays and (ii) indicate whether the one or more trays are in one of a secured position and a released position.

7. A freight load carrier to receive items thereon that is conveyable through one or more railcars for placement into a railcar, the carrier comprising:
a frame having a first end and a second end with longitudinal support members spacing the first end from the second end and a plurality of lateral support members therebetween;
an upper surface to receive one or more items thereon, the upper surface supported by the frame;
a tray propulsion engagement element on at least one of the first end and the second end, the tray propulsion engagement element configured to engage a tray propulsion system housed within the railcar; and
a conveyance facilitation element to facilitate delivery of the tray into the one or more railcars.

8. The carrier according to claim 7, further comprising:
a grating on the upper surface to provide an increased coefficient of friction.

9. The carrier according to claim 7, further comprising:
an elastomer stopper engagement element to abut a stopper.

10. The carrier according to claim 7, further comprising:
a plurality of rollers situated substantially within each of the lateral support elements.

11. The carrier according to claim 10, wherein each of the plurality of rollers have an hour-glass shaped cross-section.

12. The carrier according to claim 7, further comprising:
an end element to abut a stopper and secure the tray in a position.

13. The carrier according to claim 7, wherein the upper surface has a first portion that spaces a second portion from a third portion, the second portion and the third portion having a structural integrity that is greater than a structural integrity of the first portion.

14. The carrier according to claim 7, further comprising:
a bulkhead on at least one of the first end and the second end to secure via abutting engagement the one or more items received on the upper surface.

15. The carrier according to claim 14, wherein the bulkhead has a longitudinally adjustable element to permit incremental adjustments of the bulkhead depending on the one or more items received on the upper surface.

16. The carrier according to claim 7, further comprising:
guides on each of the longitudinal support members facing away from the frame.

17. The carrier according to claim 16, wherein the guides have a “C” configuration to receive an element therein.

18. A railcar comprising:
a housing having a housing cavity therein and end doors on opposite ends of the housing;
at least two floors within a housing cavity, each of the at least two floors configured to receive a tray;
a propulsion means on each of the at least two floors configured to engage and move the tray; and
an operation station to receive a hand tool to permit independent operation of the propulsion means on each of the at least two floors.

19. The railcar according to claim 18, wherein the railcar has three floors, each of the three floors configured to receive a tray.

20. The railcar according to claim 18, wherein each of the end doors have a left door and a right door that open outwardly with respect to the housing to expose the housing cavity, each of the left door and right door having a split to enable folding of the left door and the right door away from the housing.

21. The railcar according to claim 18, wherein each of the end doors have a gasket configured to be compressed when the end doors are in a closed configuration and decompressed when the doors are in an open configuration.

22. The railcar according to claim 18, further comprising:
a splash guard secured to one of the end doors to deter water from entering the housing cavity.

23. The railcar according to claim 22, wherein the splash guard is secured to an interior of one of the end doors and extends in a first direction away from the one of the end doors and is bent in a second direction toward another of the end doors.

24. The railcar according to claim 18, wherein each of the at least two floors have a track on either side of the floor.

25. The railcar according to claim 24, wherein the propulsion means is situated between the track on either side of the floor.

26. The railcar according to claim 24, wherein the propulsion means includes an abutment element that is (i) biased in a direction, (ii) rotatable, (iii) connected to a torsion spring, and (iv) connected to the operation station.

27. The railcar according to claim 24, wherein the abutment element is configured to rotate upon abutting engagement of a tray.

28. The railcar according to claim 24, wherein the abutment element is biased in an upward direction via the torsion spring.

28. The railcar according to claim 24, is selectively rotatable in a first direction and a second direction via the operation station.

29. The railcar according to claim 18, further comprising:
an indicative securing element that (i) is selectively moveable from a secured configuration to secure a load and an unsecured configuration to permit movement of a load and (ii) indicates when the indicative securing element is in the secured configuration or the unsecured configuration.

30. The railcar according to claim 29, wherein the indicative securing element is connected to a stopper.
